(19) United States
(12) Patent Application Publication
(10) Pub. No.: US 2011/0101848 A1
(43) Pub. Date: May 5, 2011

(54) FLUORESCENCE-BASED LIGHT EMITTING DEVICE

(75) Inventors: Jean-Francois CORMIER, Saint-Augustin-de-Desmaures (CA); Michel FORTIN, Lac Beauport (CA)

(73) Assignee: Institut National D'Optique, Quebec (CA)

(21) Appl. No.: 12/609,875

(22) Filed: Oct. 30, 2009

(51) Int. Cl. H01J 1/62; C09K 11/02; C09K 11/08

(52) U.S. Cl. 313/483; 252/301.36; 252/301.4 R; 252/301.4 F

(57) ABSTRACT

A light emitting device generates a broadband light beam in response to an excitation light beam. The light emitting device includes a matrix in which is provided a plurality of fluorescent components of different types. Each type of fluorescent component has an absorption spectrum and an emission spectrum respectively differing from absorption and emission spectra of other types of fluorescent components. The matrix and the types, concentration and positioning of the fluorescent components are selected to output the broadband light beam in response to the excitation light beam. The types of fluorescent components may include fluorescent compounds, quantum dots or a combination thereof. The light-emitting device above may be used as a fluorescent standard, or incorporated into a light source. Scattering elements may also be incorporated in the matrix.

### FIELD OF THE INVENTION

The present invention relates to light emitting devices for fluorescence standards, phantoms or light sources and more particularly concerns a light emitting device based on multiple fluorescent components and emitting a broadband or tailored light beam.

### BACKGROUND OF THE INVENTION

Fluorescence-based spectroscopy constitutes an increasingly important analytical tool for biotechnological applications. Exogenous or endogenous fluorescent agents are used as biochemical indicators in areas ranging from microscopy to in vivo molecular imaging.

Fluorescent standards are compounds or systems having a known fluorescent response to a given excitation wavelength or spectrum. Compounds made to reproduce exactly the fluorescent response of a particular fluorescent agent are referred to as fluorescent “phantoms”. Both fluorescence standards and phantoms, collectively referred to hereinbelow as “fluorescent references”, are often necessary either as absolute radiant calibration references or for relative inter-systems measurements comparison.

Fluorescent references are usually pure compounds used under specific conditions in which their optical properties are well known. Examples of such compounds include the STARNA Scientific Ltd. (trademark) reference material from Optiglass (http://www.optiglass.com/). These reference materials are provided in kits of six (6) blocks, each having a different fluorophore component in a PMMA (Poly-methyl methacrylate) matrix. Each block has a different specific emission wavelength in response to a different specific excitation wavelength. Other standards, such as the PTI FA-2036 have a wider excitation waveband, but a variable emission spectrum spread over four (4) discreet wavebands.

Individual quantum dots are also known to be of potential interest as fluorescent references, as they have a wide excitation spectrum and a better quantum efficiency than organic fluorescent compounds. However, they have a narrow emission spectrum, generally of about 20 nm at FWHM.

While each prior art fluorescent references can be useful for the particular applications for which their optical properties are appropriate, there is currently no know fluorescent reference emitting light over a broadband spectrum, which limits the quantitative value of measurements taken with different fluorescence-based spectroscopy equipment. There is therefore a need for a fluorescent reference emitting light over a broadband spectrum.

### SUMMARY OF THE INVENTION

In accordance with one aspect of the invention, there is provided a broadband light emitting device for generating a broadband light beam in response to an excitation light beam having a spectral profile. The light emitting device first includes a matrix, which is provided with a plurality of fluorescent components of different types therein. Each type of fluorescent component has an absorption spectrum and an emission spectrum respectively differing from absorption and emission spectra of other ones of the type of fluorescent components. The matrix, the types of fluorescent components and a concentration and positioning of the fluorescent components within the matrix are selected to output the broadband light beam in response to the excitation light beam.

The types of fluorescent components may include fluorescent compounds, quantum dots or a combination thereof. The light-emitting device above may be used as a fluorescent standard.

In some embodiments, scattering elements such as TiO₂, Al₂O₃, glasses, quartz, SiO₂, polymeric microspheres or the like may be incorporated in the matrix.

According to one alternative embodiment, there is also provided light source including a broadband light emitting device as defined above, and an excitation light source generating the excitation light beam and coupled to the broadband light emitting device to propagate the excitation light beam therein.

In accordance with another aspect of the present invention, there is also provided a fluorescent phantom for mimicking fluorescent properties of a target system. The fluorescent properties determine an output light beam of the fluorescent phantom in response to an excitation light beam having a spectral profile. The fluorescent phantom includes a matrix provided with a plurality of fluorescent components of different types therein, each type of fluorescent component having an absorption spectrum and an emission spectrum respectively differing from absorption and emission spectra of other ones of the type of fluorescent components. The matrix, the types of fluorescent components and a concentration and positioning of these fluorescent components within the matrix are selected to output an output light beam mimicking the fluorescent properties of the target system in response to the excitation light beam.

Other features and advantages of the present invention will be better understood upon reading of preferred embodiments thereof with reference to the appended drawings.

### BRIEF DESCRIPTION OF THE DRAWINGS

FIG. 1 is a schematic representation of a fluorescent light emitting device according to an embodiment of the invention.

FIG. 2 is a graph showing the absorption and emission spectra of fluorescent components of two different types, and the processes of cross-absorption and re-emission.

FIG. 3 is a schematic representation of a non-scattering medium including an inclusion of fluorophore components of one type embedded in an absorbing medium.

FIG. 4 is a flow chart showing the processes of primary fluorescent emission, cross-absorption and re-emission in the medium of FIG. 3.

FIGS. 5A and 5B are graphs respectively showing the molar extinction and the fluorescence probability density of Tryptophan, Coumarin 1 and Fluorescein. FIGS. 5C and 5D are graphs showing the resulting fluorescence emission of specific mixes of these fluorophores due to cross-absorption and re-emission processes.

FIG. 6. is a schematic representation of an optical fiber matrix according to one embodiment of the invention.

FIG. 7 is a schematic representation of a fiber-based fluorescent light source according to an embodiment of the invention.

FIGS. 8A and 8B are schematic representations fluorescent light emitting devices including scattering elements, where the fluorescent components and scattering elements are respectively provided in a monolythic element and in a succession of layers.

### DESCRIPTION OF PREFERRED EMBODIMENTS OF THE INVENTION

Embodiments of the present invention generally concern fluorescent light emitting devices and applications thereof.

“Fluorescence” (or fluorescent in adjective form) is herein understood to refer to any compound or system for which the absorption of a photon results in the emission of another photon of lesser energy, and therefore longer wavelength. The energy difference between the absorbed and emitted photons is generally outputted as a vibration wave called a phonon, or dissipated as heat. The difference in energy (frequency) or wavelength between the absorbed and emitted photons is called the Stokes shift.

The term “light” is used to refer to all electromagnetic radiation or any useful portion thereof, and is not limited to the visible spectrum only.

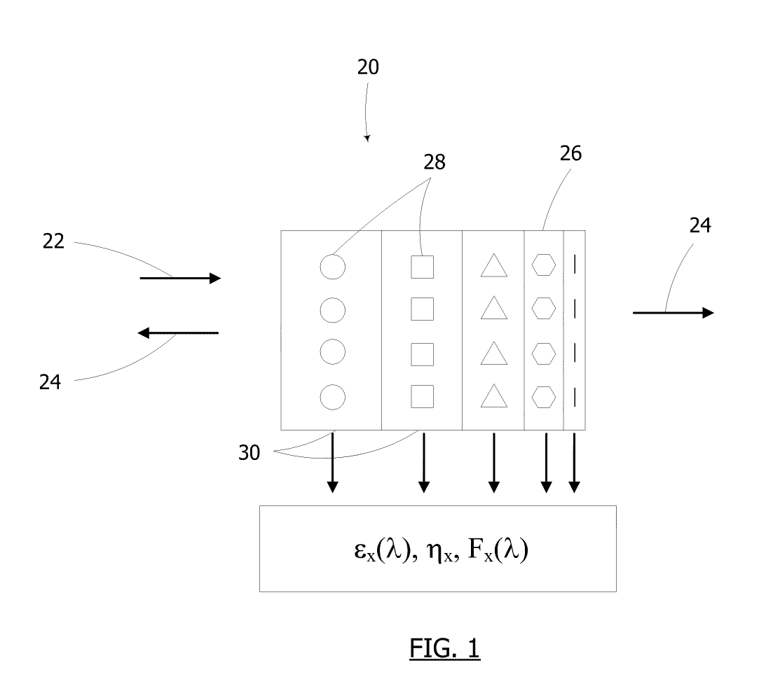

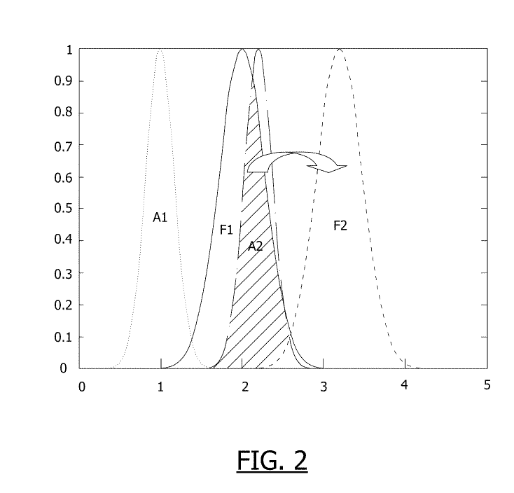

Referring to FIG. 1, there is schematically illustrated a broadband light emitting device 20 according to an embodiment of the present invention. The light-emitting device 20 is apt to generate a broadband light beam 24 in response to an excitation light beam 22. The excitation light beam 22 has a predetermined spectral profile.

In the embodiments described below, the spectral profile of the excitation light beam will be considered corresponding to a single wavelength, called herein the excitation wavelength. However, one skilled in the art will understand that the present invention could equally be use with an excitation light beam having a more complex spectral profile including several wavelengths or wavelength bands.

One skilled in the art will further understand that the expression “broadband”, as applied to the light-emitting device 20 and the light beam outputted thereby, refers to a spectral domain covering several wavelengths over a wavelength range sufficient to be useful to the target application of the device. For example, for some applications a wavelength range of at least 150 nm would be considered as broadband to one skilled in the art. This value is however given by way of example only and different wavelength ranges could be considered suitably broadband in different circumstances.

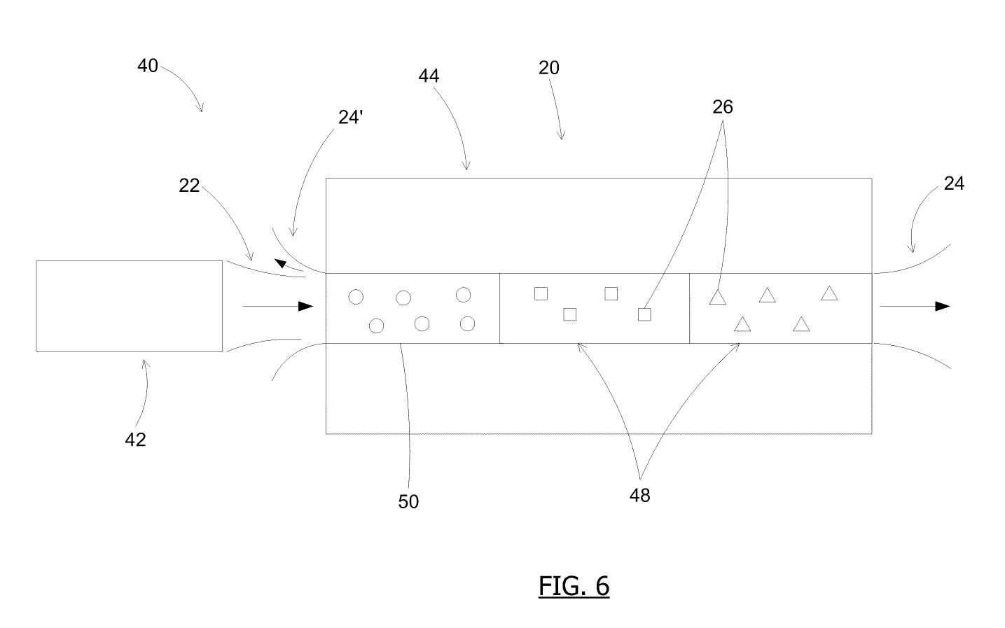

The light emitting device 20 includes a matrix 26 in which are provided a plurality of fluorescent components 28 of different types. The matrix 26 can be made of a polymer, glass, solgel or ceramic material, combinations thereof, or any other substrate in which the fluorescent components may be received. It will be understood that the matrix may be a monolythic element or embodied by a plurality of components assembled together. In the illustrated embodiment of FIG. 1, the matrix includes a succession of coextending layers 30, each layer incorporating one or more of the fluorescent components. Alternatively, with reference to FIG. 6, the matrix may be embodied by an optical fiber having successive regions of the core each doped with predetermined fluorescent components of one or more types. Alternatively, the fluorescent components may be provided in a homogeneous or inhomogeneous mix along the core of the optical fiber, within forming distinct layers. In another alternative, the fluorescent components may be provided in a cladding of the fiber, in which case they will be excited by evanescent fields associated with the guided light. Optical fiber embodiments may be particularly useful, although not limited to, the making of a light source as will be described in more detail further below. Preferably, the optical fiber has a large numerical aperture (NA) to maximize the collection of fluorescent emission, or is embodied by a Photonic Bandgap fiber which favors the spontaneous emission of fluorescence in the propagation direction of the fiber.

The fluorescent components 28 can be embodied by any system exhibiting fluorescent properties as defined above. Each fluorescent component 28 may for example be embodied by a given fluorescent compounds. Well known fluorescent compounds include for example Fluorescein, AlexaFluor and Coumarin families, as well as natural fluorophores such as Tryptophan, Tyrosine, Riboflavin, NADH, amino acids, etc Quantum dots (QD) may also be used as fluorescent components, either in combination with fluorescent compounds or embodying all the fluorescent components of the device. For example, in some embodiments, QDs may be used to cover emission bands unavailable through fluorescent compounds. QDs typically have a large absorption spectrum in the UV range up to their emission wavelength. Their quantum efficiency and molar extinction are greater than for any organic fluorescent compound, and are therefore brighter. Since they have relatively narrow emission spectra (typically around 20 nm at FWHM), a great number of QDs may be necessary in order to obtain the desired broadband output; however, a wide variety of QDs with varying emission spectra are available commercially so that all the contributions to the output beam are likely to be found among them. It is further to be noted that the use of QDs may present challenges in some embodiments, as some of them are unstable in time due to the chemical environment on which they are deposited, and that some are fabricated using toxic materials such as cadmium or selenium.

Through a proper selection of the matrix, the types of fluorescent components and the concentration and the positioning of these fluorescent components within the matrix, the optical properties of the device may be tailored so that a broadband light beam having any desired spectral profile may be produced in response to the excitation light beam.

Each type of fluorescent component 28 included in the matrix is characterised by an absorption spectrum and an emission spectrum respectively differing from absorption and emission spectra of the other types of fluorescent components, that is, fluorescent components of different types have different absorption spectra and different emission spectra. By “different” spectra, it will be understood that at least some of the wavelengths absorbed or emitted by fluorescent components of different types are not the same, but that two or more types of fluorescent components may have partially overlapping absorption spectra of partially overlapping emission spectra without departing from the scope of the present invention.

In one embodiment, the absorption spectrum of at least one type of fluorescent component at least partially coincides with the spectral profile of the excitation light beam, or includes the excitation wavelength. The absorption spectrum of each one of the remainder of the fluorescent components partially coincides with the emission spectrum of the fluorescent components of at least one other type. This promotes a “cross-absorption and re-emission” chain which is better understood with reference to FIG. 2, which schematically illustrates the spectral characteristic of fluorophore component types 1 and 2, respectively having absorption spectra A1 and A2 and emission spectra F1 and F2. The type 1 fluorophore components absorbs light within wavelength band A1, which includes the excitation wavelength (not shown) or at least partially coincides with the absorption spectrum of fluorophore components of a different type (not shown). Photons absorbed by the type 1 fluorophore components are re-emitted at wavelengths within wavelength emission spectrum F1. Some of those photons have a wavelength within the absorption spectrum A2 of the type 2 fluorophore components, and will therefore be absorbed thereby, to be re-emitted at wavelengths within the emission spectrum F2.

Preferably, the emission spectrum of each type of fluorescent components includes cross-absorption wavelengths which coincide with the absorption spectrum of the fluorescent components of at least one other type, as is the case for the wavelength in the hatched portion common to F1 and A2 in FIG. 2. The remainder of the emission spectrum define output wavelengths, which are not absorbed by other fluorescent components and contribute to the broadband light beam outputted by the device. As will be understood by one skilled in the art, the output wavelengths of all of the fluorescent components of the device will collectively define the bandwidth and spectral profile of the outputted broadband light beam.

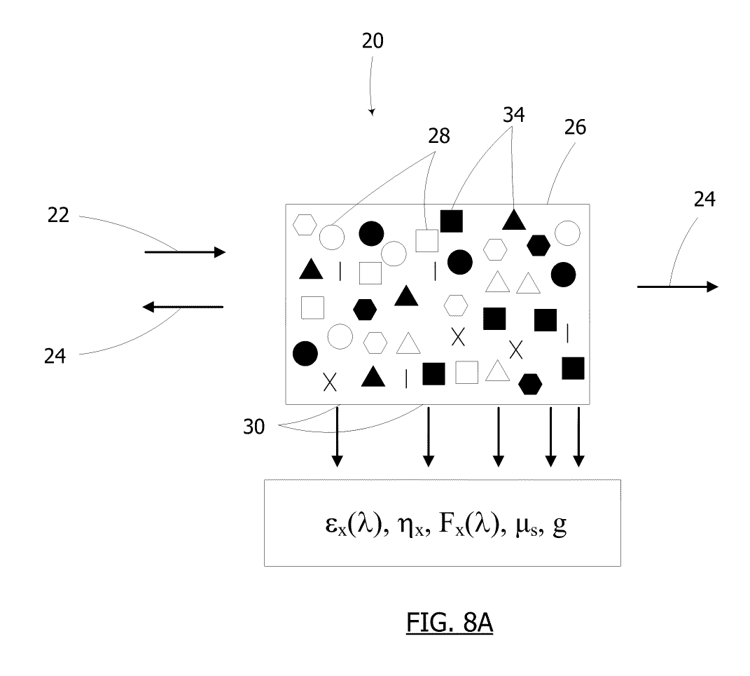

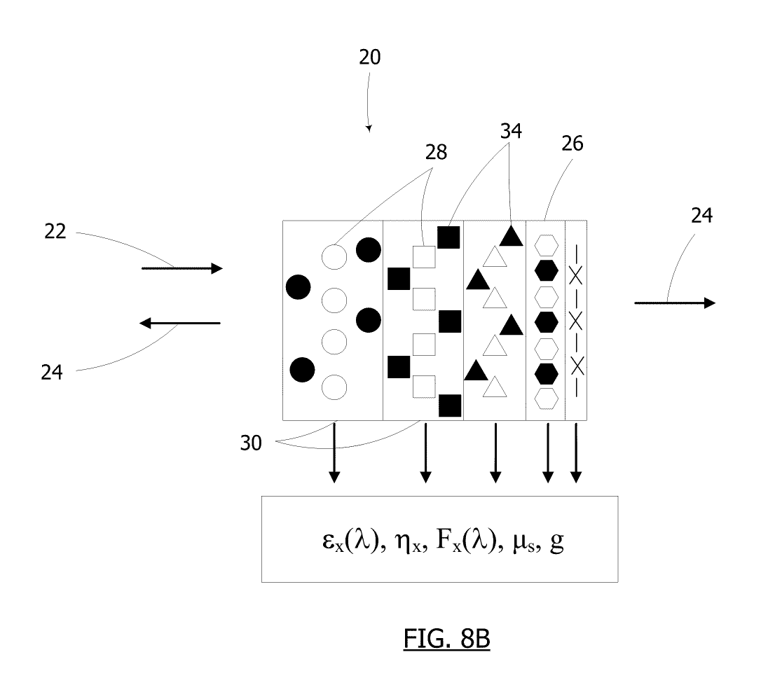

Referring to FIGS. 8A and 8B, there are shown embodiments of the invention where scattering elements 34 are incorporated within the matrix 26, in order to increase the effective path length of photons within the matrix. This provides an additional parameter which may be used to correct the spectral shape of the output broadband light beam as desired. Examples of scattering elements include TiO₂, Al₂O₃, as well as different glasses, quartz, SiO₂ and polymeric microspheres. In the embodiment of FIG. 8A, the scattering elements 34 are mixed with the fluorescent components 28 in a monolithic matrix 26, whereas FIG. 8B shows an embodiment where the matrix 26 includes a succession of coextending layers 30, each layer 30 incorporating one or more of the fluorescent components 28 and scattering elements 34. The effects of the presence of the scattering elements 34 are characterized by the scattering coefficient μₛ and the anisotropy g.

It will be readily understood that the tailoring capabilities of the present invention through selection of the matrix, the types of fluorescent components and the concentration and the positioning of these fluorescent components within the matrix are virtually endless, and that when included, the selection, size and position of the scattering elements provide an even greater versatility. in order to facilitate the selection of appropriate parameters, a theoretical model of the fluorescence generated by fluorophores in a matrix as well as guidance and numerical examples are given in the section below.

### Theoretical Model

In the next sections, a model which takes into account all the transformations of the light that propagates in a fluorescent and absorbing medium is presented, as well as results from supporting experiments. These considerations may be useful to one skilled in the art to determine proper parameters to tailor the optical properties of a device according to an embodiment of the invention in view of its target application.

1. Generation of Fluorescent Light from an Excitation Beam

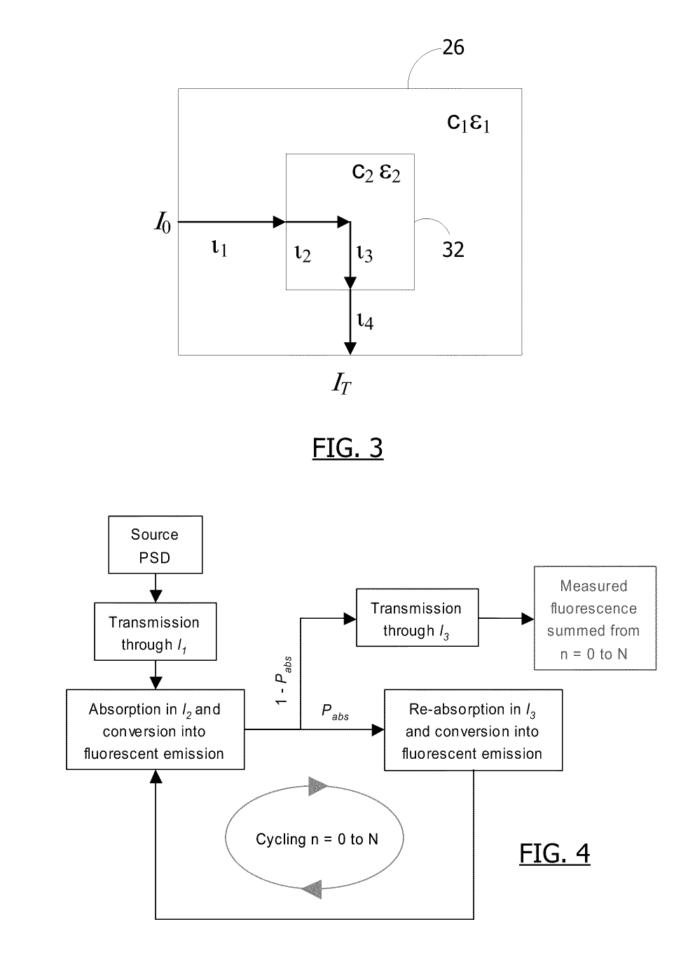

With reference to FIG. 3, the propagation of excitation light beam of intensity I₀ in a matrix 26 assumed to define a non-scattering medium is considered. A fluorescent region 32, considered to include a plurality of fluorophore components of the same type, is included within the matrix 26.

In order to derive a relation between the intensity of the excitation light beam and the fluorescent emission intensity, one must consider the series of paths and transformations that light takes between the incident source and the detector. In general the problem may be broken down into four parts:

1. attenuation of incident light beam before it reaches the fluorophore
2. absorption and conversion of incident light into fluorescent emissions
3. absorption and re-emission of the emitted fluorescent light by the fluorophore
4. attenuation of emitted light before is reached the detector.

### 1.1. Attenuation of Incident Light Beam Before it Reaches the Fluorophore

Consider an excitation light beam of wavelength λ and intensity I₀. Following Beer's law the radiant intensity of the beam decreases exponentially over a pathlength I₁,

I₁=I₀10^{-ε}^{₁}^{(λ}^{ₑₓ}^{)c}^{₁}^{l}^{₁} (1)

where ε₁(λ) is the molar extinction coefficient of non-fluorescent absorbers within the matrix, c₁ is the concentration of the absorbers, l₁ is the optical pathlength between the point of illumination and the fluorophore and the subscript ex refers to the excitation light beam.
1.2. Conversion of Incident Light into Fluorescent Emissions

Next, the light of intensity I₁ entering the fluorescent region traverses it while all the while being absorbed by the fluorophore. The pathlength through the fluorescent region is I₂. Note that in a scattering medium I₂ would represent a mean pathlength. The intensity exiting is,

I₂−I₁10^{ε}^{₂}^{(λ}^{ₑₓ}^{)c}^{₂}^{l}^{₂} (2)

The total power absorbed over this pathlength is,

I_{abs}=I₁−I₂=I₀10^{-ε}^{₁}^{(λ}^{ₑₓ}^{)c}^{₁}^{l}^{₁}(1−10^{-ε}^{₂}^{(λ}^{ₑₓ}^{)c}^{₂}^{l}^{₂} (3)

Since not all of the power absorbed is converted into fluorescent light, one must multiply by the quantum efficiency, η. Additionally, the emitted radiant energy covers a continuum of wavelengths E(λ). This continuum is the emission spectral profile of the fluorophore at the point of generation. For the purposes of this discussion E(λ), is normalized to unit intensity (or probability). The fluorescent intensity produced therefore equals,

I(λₑₘ)=ηE(λₑₘ)I₀10^{-ε}^{₁}^{(λ}^{ₑₓ}^{)c}^{₁}^{l}^{₁}(1−10^{-ε}^{₁}^{(λ}^{ₑₓ}^{)c}^{₁}^{l}^{₂}) (4)

### 1.3 Absorption and Re-Emission of the Emitted Fluorescent Light by the Fluorophore

Let us now consider the processes that occur when the fluorescent light is re-absorbed by a fluorophore component of the same type. This occurs because there typically exists a spectral overlap between the excitation and emission spectral profiles of a given fluorophore type. Consider, the probability of absorption of fluorescent light as it traverses an optical pathlength, I₃:

a(λₑₘ)=1−10^{-ε}^{₂}^{(λ}^{ₑₘ}^{)c}^{₂}^{l}^{₃} (5)

The total fraction of photons absorbed by the fluorophore is:

α=∫_{λ}E(λ)[1−10^{-ε}^{₂}^{(λ}^{ₑₘ}^{)c}^{₂}^{l}^{₃}]dλ (6)

Due to self-absorption, the spectral profile of the primary emission after traversing a pathlength, I₃ is different than E(λ). The spectral profile may be represented by F₀(λ),

F₀(λₑₘ)=[1−a(λₑₘ)]E(λₑₘ) (7)

The light absorbed during this process may be re-emitted again with a relative intensity determined by the quantum efficiency and the absorption probability of the fluorophore. This relative intensity (relative to E(λₑₘ)) of the re-emitted light from absorbed primary emissions is,

F₁(λₑₘ)=ηα[1−a(λₑₘ)]E(λₑₘ)=ηαF₀(λₑₘ) (8)

The absorption—emission chain may continue, and after n steps it is found that the observed total emission is the sum of all contributions due to all absorptions and re-emission steps:

$${F}_{T} ( {λ}_{em} ) = [ 1 - a ( {λ}_{em} ) ] E ( {λ}_{em} ) {\sum }_{i = 0}^{n} {( ηα )}^{i} \qquad ( 9 )$$

Due to the nature of self-absorption and re-emission, the contribution to the observed emission from each step falls very quickly. Therefore the geometric sum 1+ηα+(ηα)²+ . . . may be replaced by (1−ηα)⁻¹ if one assumes an infinite number of steps. The observed total emission may be now written as,

F_{T}(λₑₘ)=(1−ηα)⁻¹[1−a(λₑₘ)]E(λₑₘ) (10)

The observed emission intensity exiting the fluorescent region 32 is then,

I_{T}(λₑₘ)=η(1−ηα)⁻¹[1−a(λₑₘ)]E(λₑₘ)I₀10^{-ε}^{₁}^{(λ}^{ₑₓ}^{)c}^{₁}^{l}^{₁}(1−10^{-ε}^{₂}^{(λ}^{ₑₓ}^{)c}^{₂}^{l}^{₂}) (11)

### 1.4. Time-Dependence of the Emission

Likewise, the time-dependence of the emission may be treated in the same manner as with the development of F_{T}(λₑₘ). For the primary emission the emission decays exponentially at a rate, 1/τ. The normalized intensity of this primary emission is,

V₀(t)=τ⁻¹e^{-t/τ} (12)

The first re-emission V₁(t) may be described by the convolution of the primary emission which acts as an excitation source,

V₁(t)−(τ⁻¹e^{-t/τ})*(τ⁻¹e^{-t/τ})=τ⁻²te^{-t/τ} (13)

Note that V₁(t) is also normalized. After the nth re-emission, Vₙ(t) is

$${V}_{n} ( t ) = \frac{{t}^{n} {e}^{- t / τ}}{{τ}^{n + 1} n !} \qquad ( 14 )$$

Putting the time-dependent behaviors together with Fₙ(λₑₘ) one obtains,

$$\begin{matrix}{I}_{o} ( {λ}_{em} , t ) = [ 1 - a ( {λ}_{em} ) ] E ( {λ}_{em} ) {τ}^{- 1} {e}^{- t / τ} & ( 15 ) \\ {I}_{1} ( {λ}_{em} , t ) = ηα [ 1 - a ( {λ}_{em} ) ] E ( {λ}_{em} ) {τ}^{- 2} t {e}^{- t / τ} = {ηατ}^{- 1} {tI}_{0} ( {λ}_{em} , t ) & ( 16 ) \\ {I}_{n} ( {λ}_{em} , t ) = \frac{1}{τ n !} {( \frac{t ηα}{τ} )}^{n} {I}_{0} ( {λ}_{em} , t ) & ( 17 )\end{matrix}$$

The observed time resolved emission is the sum of all contributions due to all absorptions and re-emission steps,

$${I}_{T} ( {λ}_{em} , t ) = [ 1 - a ( {λ}_{em} ) ] E ( {λ}_{em} ) {τ}^{- 1} {e}^{- t / τ} {\sum }_{i = 0}^{n} \frac{1}{n !} {( \frac{t ηα}{τ} )}^{n} \qquad ( 18 )$$

The sum is a MacLaurin series for an exponential function. Therefore I_{T}(λ,t) may be approximated in the limit as,

I_{T}(λₑₘ,t)=[1−a(λₑₘ)]E(λₑₘ)τ⁻¹e^{-t}(1−ηα)/τ (19)

One may further define the effective lifetime τ, as,

$${τ}_{eff} = \frac{τ}{1 - ηα} \qquad ( 20 )$$

where τ is the lifetime at infinite dilution. Equation (20), which is a classical result, may be used to correct for the effects of concentration on fluorescent lifetime.

After rearranging Equation (20) one finds that,

$$\frac{τ}{{τ}_{eff}} = 1 - η {\int }_{λ} E ( λ ) [ 1 - {10}^{- {ɛ}_{2} ( λ ) {c}_{2} {l}_{3}} ] d λ \qquad ( 21 )$$

If either c₂, I₃, η or ηε₂(λ)dλ approach 0, then τ_{eff}→τ. This result makes physical sense and demonstrates how self-absorption may be minimized. Combining Equation (19) (which is an expression of the relative fluorescence intensity assuming unit intensity at I₃=0) with Equation (4) (the steady state intensity assuming one excites the sample with a given wavelength and power) leads to:

I_{T}(λₑₘ,t)=I₀η[1−a(λₑₘ)]E(λₑₘ)10^{-ε}^{₁}^{(λ}^{ₑₓ}^{)c}^{₂}^{l}^{₂})τ⁻¹e^{-t(1-ηα)/τ} (22)

where the term (1−ηα)⁻¹ for re-emission has been left-out since it is naturally included in the development of equation (19), and appears as a results of integration of equation (22) over time to yield the CW intensity.

### 1.5. Attenuation of Emitted Light Before it Reaches the Detector

As with Step 1, Beer's law may be used to estimate how the radiant emitted intensity decreases exponentially over a given pathlength. If the pathlength is I₄, Equation (22) becomes

I_{T}(λₑₘ,t)=I₀η(1−ηα)⁻¹[1−a(λₑₘ)]E(λₑₘ)10^{-ε}^{₁}^{(λ}^{ₑₓ}^{)c}^{₁}^{l}^{₁}^{-ε}^{₁}^{(λ}^{ₑₘ}^{)c}^{₁}^{l}^{₄}(1−10^{-ε}^{₂}^{(λ}^{ₑₓ}^{)c}^{₂}^{l}^{₂})τ⁻¹e^{-t(1-ηα)/τ} (23)

In the case where the measured signal is integrated over time (CW measurements), the time-response of equation (23) must be integrated over time. It can be easily shown that the integration of the time dependence of this equation from 0 to infinity equals (1−ηα)⁻¹. Thus, the CW intensity I_{cw}(λₑₘ) is given by

I_{cw}(λₑₘ)=I₀η(1−ηα)⁻¹[1−a(λₑₘ)]E(λₑₘ)10^{-ε}^{₁}^{(λ}^{ₑₓ}^{)c}^{₁}^{l}^{₁}^{-ε}^{₁}^{(λ}^{ₑₘ}^{)c}^{₁}^{l}^{₄}(1−10^{-ε}^{₂}^{(λ}^{ₑₓ}^{)c}^{₂}^{l}^{₂}) (24)

This equation can be used to model the time-integrated intensity of the fluorescent signals collected.

To bring out the physical meaning of this equation, which describes the absorption and fluorescence process using the configuration detailed in FIG. 3, Equation (24) is restructured. This allows the reflection of the chronological sequence of the events. The restructured Equation (25) is expressed in terms of

$$\frac{{I}_{cw} ( {λ}_{em} )}{{I}_{0} ( {λ}_{ex} )}$$

which defines the fraction of excitation photons converted into fluorescence and measured after traveling the pathlength I₄,

$$\frac{{I}_{cw} ( {λ}_{em} )}{{I}_{0} ( {λ}_{ex} )} = \underbrace{{10}^{- {ɛ}_{1} ( {λ}_{ex} ) {c}_{1} {l}_{1}} ( 1 - {10}^{- {ɛ}_{2} ( {λ}_{ex} ) {c}_{2} {l}_{2}} )}_{A} \cdot \underbrace{η E ( {λ}_{em} ) {10}^{- {ɛ}_{2} ( {λ}_{em} ) {c}_{2} {l}_{3}}}_{B} \cdot \underbrace{{( 1 - ηα )}^{- 1}}_{C} \underbrace{{10}^{- {ɛ}_{1} ( {λ}_{em} ) {c}_{1} {l}_{4}}}_{D} \qquad ( 25 )$$

Formally, the fraction is given by Equation (25) integrated over the spectral bandpass of detection. Part A of the Equation (25) deals with the absorption of the photons of the excitation light beam traveling in sections I₁ and I₂. Section I₁ attenuates the incident photons before reaching the section I₂. In the section I₂ the absorbed photons are converted into fluorescence emission. The functional form taken by part A of the equation infers that a maximum fraction of absorbed photons is reached in section I₂, at a certain concentration level, for a fixed excitation wavelength.

Part B of the Equation (25) represents the spectral profile of the primary emission after propagation through section I₃. Multiplication of the part A and B describes the fraction of photons absorbed in section I₂, which emit fluorescence and are transmitted through section I₃. Then, depending on the concentration level in the section I₃, one can deduce how the self-absorption process will modify the fluorescence spectral profile. This absorption process is highly dependent on the overlap between the absorption and emission bands of the fluorophore. Thus, only the wavelength region of the fluorescence profile of the primary emission that overlaps with the absorption profile will be attenuated.

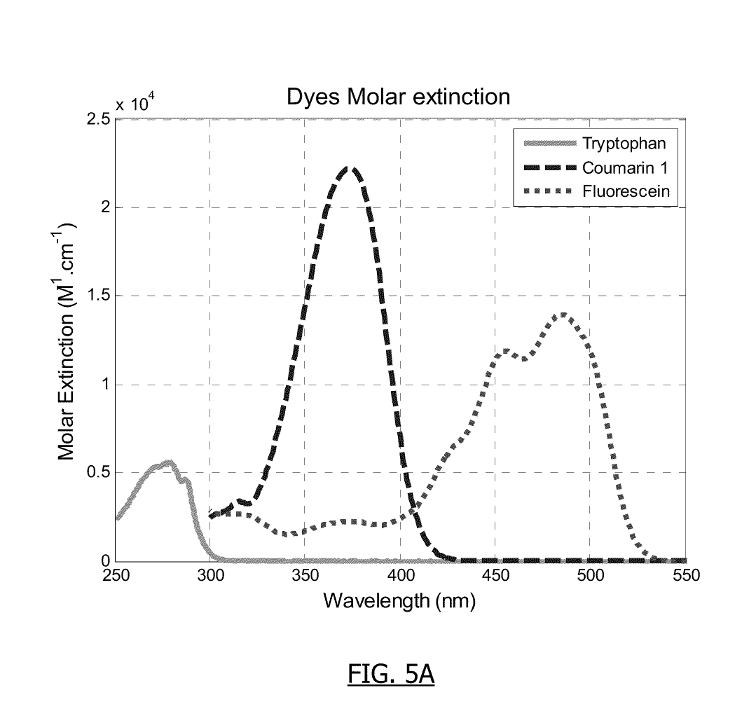

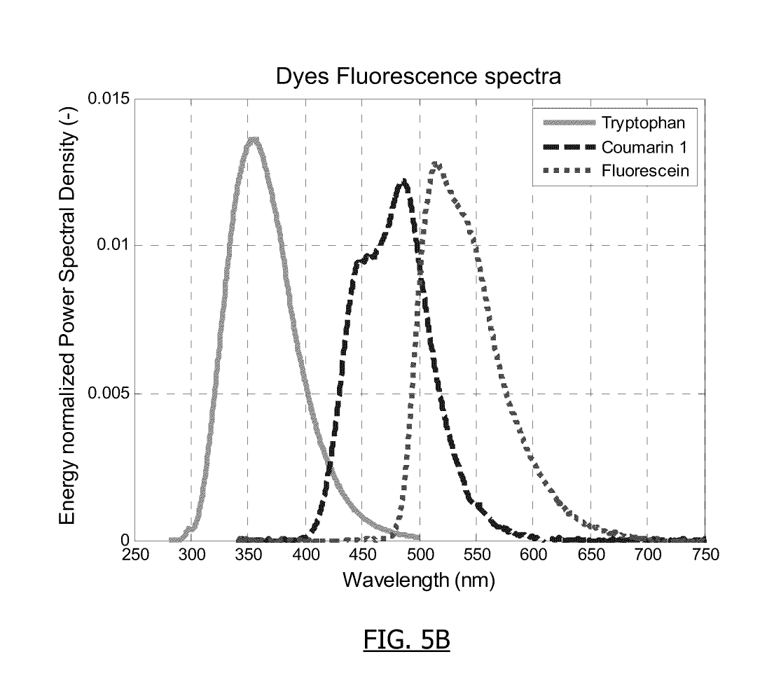

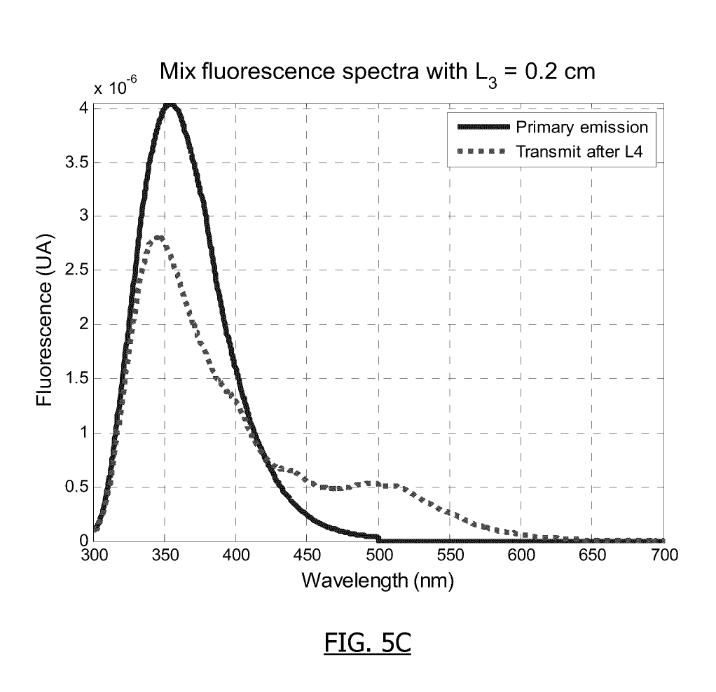

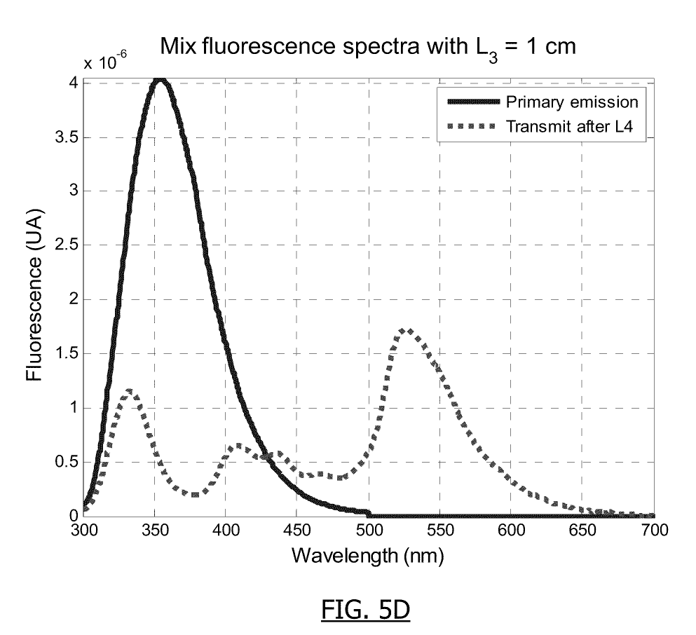

Part C of the Equation (25) considers the re-emission process that can occur after self-absorption in section I₃. FIGS. 5A and 5B show the molar extinction and the fluorescence probability density of the three examples of fluorescent compounds, Tryptophan, Coumarin 1 and Fluorescein. FIGS. 5C and 5D show the resulting spectral emission from a mix of these fluorophore at a concentration of 1 μM, for two different pathlength I₃. One can visualize the important impact of the overlap integral between the molar extinction coefficient and fluorescence probability density spectral profile. In other words, the re-emission process depends on the Stokes shifts exhibited by the fluorophore, the peak molar absorptivity, the pathlength I₃ and the concentration and quantum yield of the fluorophore. Part D of the Equation (25) deals with the self-absorption in section I₄ which increases the deformation of the spectral profile just before detection.

### 2. Extension to Multiple Fluorophore Types

As mentioned above, the light emitting devices according to embodiments of the invention includes fluorophore components of different types. The extension below to the model developed above therefore takes into account a finite number of absorber/fluorophores, as well as a broad or multi-wavelength illumination source. FIG. 4 shows the conceptual process used herein.

Let's define the source term as a power spectral density I_{S}(λ),

I_{S}(λ)=I₀S(λ) (40)

Where I₀ is the total number of photons hitting the matrix (or the total power or intensity) and S(λ) is the normalized power spectral density (PSD) of the source (∫₀^{∞}S(λ)dλ=1). Let's also assume the presence of Jₐ fluorophores in section I₁ and I₄ of the medium defined as the region a, and J_{b} in sections I₂ and I₃ defined as the region b. The overall absorbance in either section of length I is then given by,

$${A}_{tot} ( l , λ ) = l {\sum }_{j = 1}^{J} {ɛ}^{j} ( λ ) {c}^{j} \qquad ( 41 )$$

The first step is the transmission of the initial PSD of the source through section I₁ of the medium, and the absorption of these photons by the J fluorophores of the sections I₂. Thus, the PSD of absorption in section I₂ is given by,

PSD_{abs}(λ)=Iₛ(λ)[1−P_{abs}^{l}^{₁}(λ)]P_{abs}^{l}^{₂}(λ) (42)

With

P_{abs}¹(λ)=1−10^{-A}^{ₜₒₜ}^{(1,λ)} (43)

Which is the probability of absorption through a medium of total absorbance Aₜₒₜ(λ) given by equation (41). Equation (42) gives the total PSD of absorption. In order to establish the quantity of photons that are absorbed by each of the fluorophores, one must use the individual absorbance of each fluorophore for one specific wavelength. One skilled in the art will understand that the fraction of photons absorbed by fluorophore j at each wavelength λ can be written,

$${f}^{j} ( λ ) = \frac{{A}^{j} ( l , λ )}{{A}_{tot} ( l , λ )} = \frac{{ɛ}^{j} ( λ ) {c}^{j}}{{\sum }_{j = 1}^{J} {ɛ}^{j} ( λ ) {c}^{j}} \qquad ( 44 )$$

More formally, the ratio is in fact related to the total effective “surface” of absorption (cross-section times concentration) of each fluorophore to the total “surface” of absorption of the medium. Thus, the total number of photons absorbed by each fluorophore j after the path I₂ M^{j} is given by the integral over the wavelength of equation (42) multiplied by equation (44),

M^{j}=∫₀^{∞}PSD_{abs}(λ)f^{j}(λ)dλ=∫₀^{∞}Iₛ(λ)[1−P_{abs}¹^{₂}(λ)]P_{abs}^{l}^{₂}(λ)dλ (45)

The total primary fluorescence generated from this absorption is then the sum of the contribution of each fluorophore,

$${F}_{0} ( λ ) = {\sum }_{j = 1}^{J} {η}^{j} {E}^{j} ( λ ) {M}^{j} \qquad ( 46 )$$

In order to take into account the re-absorption/re-emission processes, we model the situation conceptually as shown in FIG. 4. The total fluorescence measured at the output of section I₃ is given by the sum of all the fluorescence generated by the re-absorption/re-emission steps transmitted through the path I₃, where the “source” input for each cycle is given by the re-absorbed portion of fluorescent photons of the previous cycle. Formally, the fluorescence source term for step n+1 is the total

$${F}_{n + 1} ( λ ) = {\sum }_{j = 1}^{J} {η}^{j} {E}^{j} ( λ ) {N}_{n}^{j} \qquad ( 47 )$$

And the fluorescence exiting section I₃ for the step n→n+1 is given by,

F′ₙ₊₁(λ)=[1−P_{abs}^{l}^{₃}(λ)]Fₙ(λ) (48)

Where N^{j} is the number of photons from the fluorescence signal Fₙ(λ) absorbed by fluorophore j through section I₃,

Nₙ^{j}=∫₀^{∞}Fₙ(λ)P_{abs}^{l}^{₃}(λ)f^{j}(λ)dλ (49)

Finally, the total fluorescence emission exiting the medium after traversing section I₄ is given by the sum of all these steps and fluorophores contributions multiplied by the spectral transmission of section I₄,

$${I}_{cw} ( λ ) = [ 1 - {P}_{abs}^{{l}_{4}} ( λ ) ] {\sum }_{n = 0}^{∞} {F}_{n}^{′} ( λ ) \qquad ( 50 )$$

### Applications

In one example, a light emitting device as described above may be tailored to serve as a fluorescent standard.

As mentioned above, fluorescent standards are compounds or systems having a calibrated known fluorescent response to a given excitation wavelength or spectrum. Such standards can be used as absolute radiant calibration references or for relative inter-systems measurements comparison.

For example, a standard having the largest possible emission spectrum, and calibrated for absolute or relative spectral irradiance could be used to calibrate a series of similar spectrofluorometers, fluorescence microscopes or plate array readers of the same type, in order to be able to compare the data collected by each systems.

As also mentioned above, compounds made to reproduce exactly the fluorescent response of a particular fluorescent agent are referred to as fluorescent “phantoms”. The principles detailed above may therefore be used to build a fluorescent phantom which mimics the fluorescent properties of a target system. The target system may for example be the autofluorescence of specific human or animal tissues excited in the UV (proteins fluorescence), all having different spectral distributions. The diversity of spectral fluorescence distribution for specific tissue is related to the relative content of several components such as proteins, NADH, flavins, porphyrins. The desired fluorescent properties determine the spectral profile of the output light beam of the fluorescent phantom in response to a given excitation light beam. While the output light beam may be broadband as per the definition above, phantoms according to this aspect of the invention are not limited to broadband outputs and can generate any output beam including specific spectral features of varying intensity as dictated by the nature or the target system. For example, NIR optical tomography and fluorescence systems for several applications (such as breast cancer monitoring devices) are regularly deployed in different sites and hospital to conduct clinical trials. It is of utmost importance to be able to calibrate the systems against a common reference in order to be able to compare the data obtained from different instruments. In this case, a standard phantom mimicking the effective spectral emission profile of the fluorescent tag(s) in the context of the application ensure that the calibration will be accomplished in conditions as close as possible from the application conditions. Moreover, the phantom being a calibrated standard, it allows comparing the data collected from each system.

In order to provide such an output light beam, the phantom includes a chemical matrix, such as a polymer or solgel material, in which are provided a plurality of fluorescent components of different types. The spectral properties of the fluorescent components are preferably similar to the ones described with respect to the light emitting device described above. The matrix, the types of fluorescent components and the concentration and positioning of the fluorescent components within the matrix are selected to mimic the fluorescent properties of the target system in response to the excitation light beam.

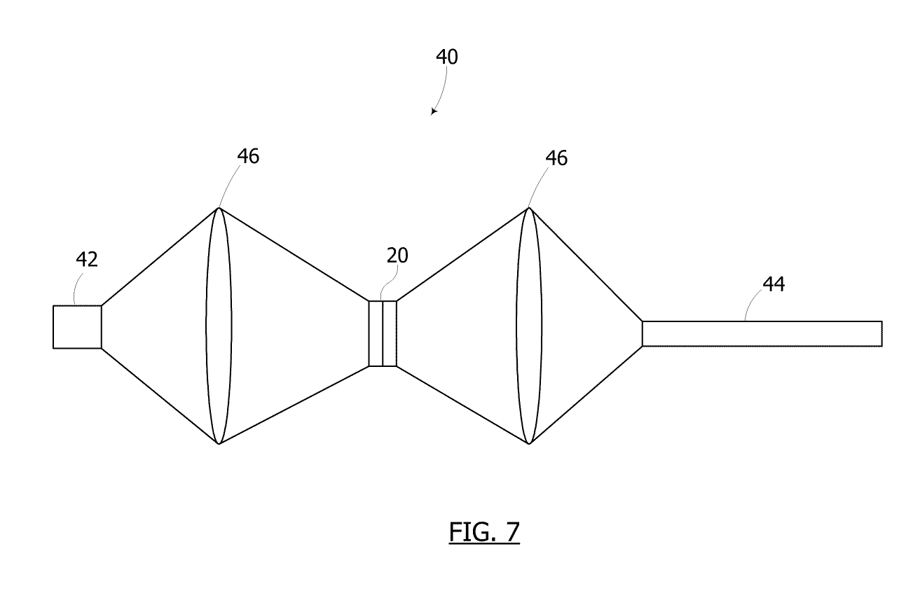

In accordance with another application, and with reference to FIG. 7, there may be provided a light source 40 which incorporates a broadband light emitting device 20 as described above. Such a light source 40 additionally includes an excitation light source 42 which generates the excitation light beam 22 and is coupled to the broadband light emitting device 20 to propagate the excitation light beam 22 therein. The outputted broadband light beam 24 may be coupled to a waveguide such as an optical fiber 44 or the like for propagation therein. Any appropriate optical component may be added to direct, focus or otherwise affect the light propagating through the source 40 as will be readily understood by one skilled in the art. In the illustrated embodiment, lenses 46 are provided between the excitation light source 42 and the light-emitting device 20 as well as between the light emitting device 20 and the optical fiber 44. Preferably, the design of the light source 40 involves a good focusing of the light to increase the overall brightness.

Alternatively, with reference to FIG. 6, the fluorescent components 26 can be embedded in alternate regions 48 of the core 50 of an optical fiber 44 and the photonic bandgap type, which defines the light-emitting device 20 in this embodiment. Such a light source 40 may additionally include an excitation light source 42 which generates the excitation light beam 22 and is coupled to the broadband light emitting device 20 to propagate the excitation light beam 22 therein. The light-emitting device 20 is apt to generate broadband light beams 24 and 24′ in opposite directions in response to the excitation light beam 22. The use of a Photonic Bandgap fiber should provide much higher brightness than similar implementation using non-photonic bandgap fiber. The fluorescence emission generated in the core of the fiber should be generated essentially in the direction of propagation of the fiber, due to the nature of the guiding process used in the Photonic Bandgap fibers. Indeed, in these fibers, the light is guided along the direction of propagation by inhibiting the emission of light (spontaneous emission) in the direction transverse to the propagation. This would ensure that all the fluorescent photons be emitted in the direction of propagation, thus increasing the brightness of the source as compared to the use of a standard fiber into which the fluorescent photons are emitted in all direction (4π steradians).

Of course, numerous modifications could be made to the embodiments above without departing from the scope of the invention as defined in the appended claims.

1. A broadband light emitting device for generating a broadband light beam in response to an excitation light beam having a spectral profile, comprising a matrix provided with a plurality of fluorescent components of different types therein, each type of fluorescent component having an absorption spectrum and an emission spectrum respectively differing from absorption and emission spectra of other ones of said type of fluorescent components, wherein the matrix, the types of fluorescent components and a concentration and positioning of said fluorescent components within said matrix are selected to output said broadband light beam in response to said excitation light beam.

2. The broadband light emitting device according to claim 1, wherein the absorption spectrum of at least one of said types of fluorescent components at least partially coincides with the spectral profile of the excitation light beam, and the absorption spectrum of each one of a remainder of said types of fluorescent components partially coincides with the emission spectrum of at least one other of said types of fluorescent components.

3. The broadband light emitting device according to claim 1, wherein the absorption spectrum of one of said types of fluorescent components includes an input wavelength defining the spectral profile of the excitation light beam.

4. The broadband light emitting device according to claim 1, wherein the emission spectrum of each type of fluorescent components comprises:
cross-absorption wavelengths coinciding with the absorption spectrum of the fluorescent components of at least one other type; and
output wavelengths contributing to said broadband light beam.

5. The broadband light emitting device according to claim 4, wherein the output wavelengths of all of said types of fluorescent components collectively define a bandwidth of at least 150 nm for said broadband light beam.

6. The broadband light emitting device according to claim 1, wherein the matrix is made of a material selected from the group comprising polymer, glass, solgel and ceramic materials and combinations thereof.

7. The broadband light emitting device according to claim 1, wherein the matrix comprises a monolithic element.

8. The broadband light emitting device according to claim 1, wherein the positioning of the fluorescent components within the matrix defines a succession of coextending layers, each layer comprising at least one of said types of fluorescent components.

9. The broadband light emitting device according to claim 1, wherein the matrix comprises an optical fiber,

10. The broadband light emitting device according to claim 9, wherein the positioning of the fluorescent components within said optical fiber defines a plurality of successive regions therealong each doped with the fluorescent components of at least one of said types.

11. The broadband light emitting device according to claim 9, wherein said optical fiber is a photonic band gap fiber.

12. The broadband light emitting device according to claim 1, wherein the types of fluorescent components comprise fluorescent compounds, quantum dots or a combination thereof.

13. The broadband light emitting device according to claim 1, further comprising scattering elements incorporated within said matrix.

14. The broadband light emitting device according to claim 13, wherein the scattering elements are selected from the group comprising TiO₂, Al₂O₃, glasses, quartz, SiO₂, polymeric microspheres and combinations thereof.

15. A fluorescent standard comprising a broadband light emitting device according to claim 1.

16. A light source comprising:
a broadband light emitting device according to claim 1; and
an excitation light source generating said excitation light beam and coupled to the broadband light emitting device to propagate said excitation light beam therein.

17. A fluorescent phantom for mimicking fluorescent properties of a target system, said fluorescent properties determining an output light beam of the fluorescent phantom in response to an excitation light beam having a spectral profile, comprising a matrix provided with a plurality of fluorescent components of different types therein, each type of fluorescent component having an absorption spectrum and an emission spectrum respectively differing from absorption and emission spectra of other ones of said type of fluorescent components, wherein the matrix, the types of fluorescent components and a concentration and positioning of said fluorescent components within said matrix are selected to mimic the fluorescent properties of the target system in response to said excitation light beam.

18. The fluorescent phantom according to claim 17, wherein the absorption spectrum of at least one of said types of fluorescent components at least partially coincides with the spectral profile of the excitation light beam, and the absorption spectrum of each one of a remainder of said types of fluorescent components partially coincides with the emission spectrum of at least one other of said types of fluorescent components.

19. The fluorescent phantom according to claim 17, wherein the absorption spectrum of one of said types of fluorescent components includes an input wavelength defining the spectral profile of the excitation light beam.

20. The fluorescent phantom according to claim 17, wherein the emission spectrum of each type of fluorescent components comprises:
cross-absorption wavelengths coinciding with the absorption spectrum of the fluorescent components of at least one other type; and
output wavelengths contributing to said output light beam.

21. The fluorescent phantom according to claim 17, wherein the matrix is made of a material selected from the group comprising polymer, glass, solgel and ceramic materials and combinations thereof.

22. The fluorescent phantom according to claim 17, wherein the positioning of the fluorescent components within the matrix defines a succession of coextending layers, each layer comprising at least one of said types of fluorescent components.

23. The fluorescent phantom according to claim 1, wherein the matrix comprises a monolithic element.
